(19) United States
(12) Patent Application Publication
(10) Pub. No.: US 2025/0030217 A1
(43) Pub. Date: Jan. 23, 2025

(54) PASSIVELY MODE-LOCKED FIBER OSCILLATOR, LASER DEVICE AND NONLINEAR CPA AMPLIFICATION SYSTEM COMPRISING SUCH A FIBER OSCILLATOR

(71) Applicant: TRUMPF LASER GMBH, Schramberg (DE)

(72) Inventors: Florian GRAF, Aichhalden (DE); Raphael SCELLE, Villingen- Schwenningen (DE); Aleksander BUDNICKI, Waldkirch (DE)

(21) Appl. No.: 18/909,972

(22) Filed: Oct. 9, 2024

Related U.S. Application Data
(63) Continuation of application No. PCT/EP2023/060059, filed on Apr. 19, 2023.

(30) Foreign Application Priority Data
Apr. 20, 2022 (DE) 10 2022 109 548.7

(51) Int. Cl. H01S 3/1112; H01S 3/00; H01S 3/067; H01S 3/16

(52) U.S. Cl. CPC H01S 3/1112; H01S 3/0057; H01S 3/06716; H01S 3/0675; H01S 3/1618

(57) ABSTRACT

A passively mode-locked fiber oscillator for generating seed pulses for nonlinear chirped pulse amplification (CPA) systems includes a bidirectional loop and a unidirectional loop coupled to one another by a loop coupler. The bidirectional loop includes a first amplifying fiber. The fiber oscillator has a total fiber length configured such that a repetition rate of the fiber oscillator is at most 10 MHz. The fiber oscillator further includes at least one dispersion compensation element configured such that the fiber oscillator has a total dispersion of 0.04 ps² to 0.1 ps².

### CROSS REFERENCE TO RELATED APPLICATIONS

This application is a continuation of International Application No. PCT/EP2023/060059 (WO 2023/203045 A1), filed on Apr. 19, 2023, and claims benefit to German Patent Application No. DE 10 2022 109 548.7, filed on Apr. 20, 2022. The aforementioned applications are hereby incorporated by reference herein.

### FIELD

Embodiments of the present invention relate to a passively mode-locked fiber oscillator, a laser device comprising such a fiber oscillator, and a nonlinear chirped pulse amplification (CPA) system comprising such a fiber oscillator or comprising such a laser device.

### BACKGROUND

There are two main classes of optical pulsed lasers, namely mode-locked and Q-switched lasers. Mode-locked lasers can generate ultrashort optical pulses having high repetition rates, while Q-switched lasers are generally used for generating high-energy pulses at relatively low repetition rates. If there is a desire to generate sub-ps pulses, the choice typically falls on a mode-locked oscillator system. In general, the repetition rate downstream of the oscillator is then adjusted to the desired value by way of a pulse selection apparatus, i.e. a pulse picker, e.g. an acousto-optic modulator (AOM) or an electro-optic modulator (EOM).

Passively mode-locked fiber oscillators typically have a repetition rate of more than 10 MHz, it being difficult to realize a lower repetition rate in the case of fiber oscillators which are formed exclusively from fiber components and do not comprise any free-space sections. In particular, there is no simple option for adapting the repetition rate if the fiber oscillator comprises exclusively fiber components and no free-space section. This is all the more true if high quality requirements are made of the spectrum of the generated laser pulses, such as when the laser pulses are used as seed pulses for a nonlinear CPA amplification system, for example. Spectra of such laser pulses are intended to have as little residual ripple as possible, in particular no ripples or modulations.

### SUMMARY

Embodiments of the present invention provide a passively mode-locked fiber oscillator for generating seed pulses for nonlinear chirped pulse amplification (CPA) systems. The fiber oscillator includes a bidirectional loop and a unidirectional loop coupled to one another by a loop coupler. The bidirectional loop includes a first amplifying fiber. The fiber oscillator has a total fiber length configured such that a repetition rate of the fiber oscillator is at most 10 MHz. The fiber oscillator further includes at least one dispersion compensation element configured such that the fiber oscillator has a total dispersion of 0.04 ps² to 0.1 ps².

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first exemplary embodiment of a passively mode-locked fiber oscillator;

FIG. 2 shows a schematic illustration of a second exemplary embodiment of a passively mode-locked fiber oscillator;

FIG. 3 shows a schematic illustration of a third exemplary embodiment of a passively mode-locked fiber oscillator;

FIG. 4 shows a schematic illustration of a fourth exemplary embodiment of a passively mode-locked fiber oscillator; and

FIG. 5 shows a schematic illustration of a one exemplary embodiment of a nonlinear CPA amplification system comprising a passively mode-locked fiber oscillator.

### DETAILED DESCRIPTION

Embodiments of the present invention provide a passively mode-locked fiber oscillator, a laser device comprising such a fiber oscillator, and a nonlinear CPA amplification system comprising such a fiber oscillator or comprising such a laser device, wherein the disadvantages mentioned are at least reduced, and preferably do not occur.

According to some embodiments, a passively mode-locked fiber oscillator for generating seed pulses is provided, wherein the seed pulses generated by the fiber oscillator are suitable for nonlinear CPA amplification systems. The fiber oscillator comprises a bidirectional loop and a unidirectional loop, wherein the bidirectional loop and the unidirectional loop are coupled to one another by a loop coupler, and wherein the bidirectional loop comprises a first amplifying fiber. The fiber oscillator has a total fiber length for which a repetition rate of the fiber oscillator is at most 10 MHz. Moreover, the fiber oscillator comprises at least one dispersion compensation element, wherein the at least one dispersion compensation element is configured in such a way that the fiber oscillator has a total dispersion in a predetermined range of 0.04 ps² to 0.1 ps². Through a suitable choice of the total fiber length, in particular also with a free-space section being dispensed with, it is possible to provide a repetition rate which is at most 10 MHz, and in particular is less than 10 MHz. At the same time, the tuning of the overall normal total dispersion to the predetermined range of 0.04 ps² to 0.1 ps² advantageously ensures that the spectrum of the generated seed pulses is suitable for the latter to be used as input pulses for amplification in a nonlinear CPA amplification system. In particular, the seed pulses generated by the fiber oscillator according to embodiments of the invention have a spectrum with little residual ripple, in particular with small ripples. Moreover, double pulses are advantageously avoided. The adjustment of the total dispersion in the predetermined range is important here for the spectrum of the generated laser pulses and the functioning of the fiber oscillator: If dispersion is too low, reproducibly stable operation of the fiber oscillator cannot be ensured; if dispersion is too high, a spectrally narrow filter is required for stable operation. Consequently, short pulses and thus wider spectra can only be generated by the influence of significant nonlinear widening per oscillator round-trip, as a result of which spectral ripples/modulations are generated. In particular, in the range for the total dispersion as proposed here, smooth spectra arise which are sufficiently wide with regard to subsequent amplification in a CPA amplification system. Through a suitable choice of the fiber length, in particular the repetition rate of the fiber oscillator can be tailored to an industrial application. In this case, there is no need for a pulse selection apparatus, in particular. This is advantageous since the complexity of the overall system can be reduced and, moreover, degradation effects can be avoided and the quality of the generated laser pulses can thus be improved at least in the longer term.

In particular, the spectrum of the generated seed pulses has less than 20% ripples.

The fact that the seed pulses generated by the fiber oscillator are suitable for nonlinear CPA amplification systems means, in particular, that the fiber oscillator is suitable for generating such seed pulses which are suitable for use in nonlinear CPA amplification systems, that is to say which are suitable in particular for being amplified in nonlinear CPA amplification systems.

In particular, the fiber oscillator is designed to generate laser pulses having a bandwidth-limited pulse duration of less than 1 ps.

In particular, the dispersion compensation element is configured as a fiber component.

A fiber oscillator is intended in particular to mean a laser oscillator that comprises at least one optical component, in particular for guiding light and/or influencing light, which comprises a fiber or consists of a fiber. In a preferred configuration, provision is made for all optical components of the fiber oscillator to be fiber components, that is to say components which in particular comprise a fiber or consist of a fiber, in particular fiber-based components or fiber-coupled components.

A loop is intended to mean an optical part of the fiber oscillator which has a first end and a second end, both the first end and the second end being coupled to the same terminal component of the fiber oscillator, here in particular to the loop coupler. This means in particular that light pulses that have traveled through the loop starting from the terminal component travel back again along the loop to the terminal component. Such a loop may be configured overall as a ring; in particular, the loop in this case consists of a ring part. It is, however, also possible for such a loop to comprise at least one ring part and at least one linear branch connected to the ring part in light guiding fashion, in particular exactly one ring part and exactly one linear branch.

A bidirectional loop is intended in particular to mean a loop in which light pulses can propagate both from the first end to the second end and from the second end to the first end—that is to say in both directions.

A unidirectional loop is intended in particular to mean a loop in which light pulses can propagate along the loop only in a specific direction, either from the first end to the second end or from the second end to the first end. Preferably, an isolator device, in particular an isolator, is arranged in the unidirectional loop, the isolator device being designed to transmit light pulses only in one direction, but to block them in the other direction, for example by using the Faraday effect, or in another suitable way. The isolator device is preferably arranged in a ring part of the unidirectional loop.

The bidirectional loop is preferably a first fiber loop.

A fiber loop is in this case intended to mean a loop that at least regionally comprises a fiber or consists of a fiber. In a preferred configuration, the fiber loop consists entirely of a fiber or is composed of a plurality of fibers connected to one another.

The unidirectional loop is preferably a second fiber loop. In particular, the unidirectional loop is preferably configured as a unidirectional ring.

According to one embodiment of the invention, the total fiber length is configured in such a way that the fiber oscillator has a repetition rate of at most 5 MHz.

The repetition rate fᵣₑₚ of the fiber oscillator is dependent on the total fiber length l in accordance with the following equation:

$${f}_{rep} = \frac{c}{n l} , \qquad ( 1 )$$

where nl is the optical path length that arises as the product of the refractive index n of the fiber components of the fiber oscillator and the total fiber length l. Equation (1) can be used in particular if the fiber components all have the same refractive index, or if at least the refractive indices of the different fiber components do not deviate from one another too much, in which case in particular a mean refractive index n can then be used as well. By contrast, if the refractive index of individual fiber components differs greatly, it is possible to switch to the following consideration:

$${f}_{rep} = \frac{c}{{\sum }_{i} {n}_{i} {l}_{i}} , \qquad ( 1 )$$

where the total optical path length is determined by summing over the partial optical path lengths nᵢlᵢ of the individual fiber components i.

The total fiber length is determined by adding the fiber length of the unidirectional loop and that of the bidirectional loop. If the fiber oscillator additionally comprises a reflecting arm—in particular as part of the unidirectional loop—the fiber length of the reflecting arm is multiplied by the factor 2 and added to the sum of the fiber length of the bidirectional loop and the fiber length of the unidirectional loop or the fiber length of that part of the unidirectional loop which is not allotted to the reflecting arm.

According to one embodiment of the invention, the total fiber length is at least 20 m. A repetition rate of at most 10 MHz, in particular at most 5 MHz, can be achieved in this way, in particular.

In one embodiment, the fiber oscillator is configured to be self-starting.

According to one embodiment of the invention, the loop coupler is configured as a 3×3 coupler. In particular, this configuration enables self-starting of the fiber oscillator in a simple manner.

The 3×3 coupler preferably comprises a plurality of ports, in particular six ports. In one embodiment of the laser apparatus, the 3×3 coupler is configured symmetrically, which means in particular that light pulses are split in equal portions among the different ports of the 3×3 coupler. In particular, the 3×3 coupler thus has symmetrical power splitting. A port is in this case intended to mean a terminal of the 3×3 coupler which can act as an input or as an output and, in particular, can be connected in light guiding fashion to a fiber.

In one embodiment, the 3×3 coupler comprises a first coupler side and a second coupler side each having-per coupler side-three ports, wherein the unidirectional loop is connected to the first coupler side and the bidirectional loop is connected to the second coupler side.

In one embodiment, the 3×3 coupler comprises a first port, a second port and a third port on the first coupler side of two coupler sides of the 3×3 coupler, wherein the 3×3 coupler comprises a fourth port, a fifth port and a sixth port on the second coupler side of the two coupler sides. The first port is directly connected in light guiding fashion to the fourth port via a fiber section, wherein the second port is directly connected in light guiding fashion to the fifth port via a fiber section, wherein the third port is directly connected in light guiding fashion to the sixth port via a fiber section. Light pulses that propagate between two ports directly connected to one another do not experience a phase jump, in particular. The 3×3 coupler is designed in particular such that light pulses can undergo crosstalk between the direct connections of the ports, in which case they experience a phase shift that is preferably—irrespective of the two connections between which a light pulse undergoes crosstalk −2π/3.

In one embodiment of the fiber oscillator, the 3×3 coupler is generally designed to impart a phase shift of 2π/3 to light pulses that undergo crosstalk between two different direct connections of the ports of the 3×3 coupler. Another embodiment is possible, too, in which the 3×3 coupler is configured asymmetrically, this then resulting in other phase shifts for the light pulses that undergo crosstalk between different direct optical connections of the ports.

In a first embodiment of the laser apparatus, a first end of the bidirectional loop is connected in light guiding fashion to the fourth port, wherein a second end of the bidirectional loop is connected in light guiding fashion to the fifth port. The second port and/or the sixth port may preferably be used to additionally couple light pulses out of the fiber oscillator, whether as useful light or for monitoring.

In another, second embodiment of the laser apparatus, the first end of the bidirectional loop is connected in light guiding fashion to the fifth port, wherein the second end of the bidirectional loop is connected in light guiding fashion to the sixth port. The second port and/or fourth port may preferably be used to couple light pulses out of the fiber oscillator, whether as useful light or for monitoring.

A first end of the unidirectional loop is connected in light guiding fashion to the third port, wherein a second end of the unidirectional loop is connected in light guiding fashion to the first port. The unidirectional loop is preferably designed—in particular by virtue of the isolator device—in such a way that a light pulse can travel along the unidirectional loop only from the third port to the first port—or vice versa.

In the present description, in particular specific embodiments of the 3×3 coupler are described taking account of specific possible arrangements and interconnections of ports of the 3×3 coupler. A person skilled in the art will readily recognize that there are other embodiments that are equivalent, almost equivalent or at least functionally identical to the arrangements described, but at any rate fulfill the same purpose.

With no intention of being tied to the theory and the concrete embodiment, the function of the fiber oscillator is explained in greater detail below in connection with the second embodiment mentioned above: A light pulse entering the 3×3 coupler via the first port from the unidirectional loop is split there into three light pulses of equal pulse energy among the fourth port, the fifth port and the sixth port. The light pulses at the fifth port and at the sixth port respectively experience a phase shift of 2π/3 in relation to the light pulse entering at the first port. The light pulse at the fifth port will be referred to below as a first light pulse, and the light pulse at the sixth port as a second light pulse. The first light pulse then travels through the bidirectional loop starting from the first end to the second end-namely from the fifth port to the sixth port, the second light pulse traveling through the bidirectional loop in the opposite direction-namely from the sixth port to the fifth port.

In particular, in the case of an asymmetric configuration of the bidirectional loop, the first light pulse and the second light pulse then experience different phase shifts, or B-integrals, during their propagation along the bidirectional loop. The difference in the B-integrals, or the phase shift between the first light pulse and the second light pulse, depends in particular on the original intensity of the light pulses-before traveling through the bidirectional loop—and the gain and/or attenuation in an asymmetry element, in particular the gain in the first amplifying fiber, that is to say in particular on a pump level of the first amplifying fiber. The attenuation may optionally also be configured variably in order to influence the phase shift.

Having arrived at the fifth port, the second light pulse then undergoes crosstalk partially into the direct optical connection between the sixth port and the third port, while again experiencing a phase shift of 2π/3. The first light pulse arriving at the sixth port is forwarded partially directly to the third port, without experiencing a phase shift. An output pulse resulting at the third port from superposition—in particular constructed interference—of the first light pulse and the second light pulse therefore depends, in particular, on the B-integrals that the light pulses experience during their propagation along the bidirectional loop.

In this case, the 3×3 coupler is designed such that even with a vanishing nonlinear phase shift between the first light pulse and the second light pulse, a finite transmission of preferably approximately 10% of the input pulse energy and a nonvanishing gradient of the phase-dependent transmission profile result, which significantly simplifies laser pulse synthesis from the noise. In particular, this facilitates the start, in particular a self-start, of mode-locked operation. As the phase shift increases, the transmission increases. The bidirectional loop therefore favors light pulses with a relatively high peak power and can therefore fulfill the function of a saturable absorber.

By varying the pump power for the first amplifying fiber in the bidirectional loop, the nonlinear phase shift between the first light pulse and the second light pulse can be variably adjusted.

At the same time, that portion of the second light pulse arriving at the fifth port which does not undergo crosstalk into the direct optical connection between the sixth port and the third port is partially directly guided across to the second port, part of the first light pulse arriving at the sixth port undergoing crosstalk into the direct optical connection between the fifth port and the second port and once again experiencing a phase shift of 2π/3.

The functioning of the first embodiment mentioned above is apparent in an analogous way.

As an alternative to the configuration of the loop coupler as a 3×3 coupler, it is also possible for the loop coupler to be configured as a 2×2 coupler. In order for the fiber oscillator to be configured in self-starting fashion, a phase shifter is preferably additionally provided in this case.

According to one embodiment of the invention, the first amplifying fiber is doped with ytterbium. This enables the overall normal total dispersion of the fiber oscillator to be tuned to the predetermined range in a simple manner.

Alternatively or additionally, the first amplifying fiber is doped with at least one element selected from a group consisting of neodymium, erbium, thulium and holmium.

In one embodiment, the first amplifying fiber is doped with exactly one of the elements selected from the group consisting of ytterbium, neodymium, erbium, thulium and holmium. In another embodiment, the first amplifying fiber is doped with a combination of at least two of the aforementioned elements, in particular with a combination of exactly two of the aforementioned elements. In one embodiment, the first amplifying fiber is doped with erbium and ytterbium (Er/Yb). In another embodiment, the first amplifying fiber is doped with thulium and holmium (Tm/Ho).

The doping element, or optionally the combination of doping elements, determines in particular an optical wavelength for the fiber oscillator: If the first amplifying fiber comprises ytterbium or neodymium as doping element, the wavelength is approximately 900 nm to 1100 nm. If the first amplifying fiber comprises erbium as doping element, the wavelength is approximately 1500 nm. If the first amplifying fiber comprises thulium or holmium as doping element, the wavelength is approximately 1900 nm to 2100 nm.

The fact that the fiber oscillator has overall a normal total dispersion, or that-expressed differently but meaning the same thing—the total dispersion of the fiber oscillator lies in the normal dispersion range, means in particular that a light pulse traveling through the fiber oscillator has experienced a normal dispersion after traveling through the fiber oscillator—that is to say that each component of the fiber oscillator has been passed through once. This in turn means that, in comparison with a temporal shape of the light pulse before traveling through the fiber oscillator, higher frequencies lag in the temporal shape of the light pulse after traveling through the fiber oscillator while lower frequencies lead. Higher frequencies thus run through the fiber oscillator more slowly than lower frequencies. This does not necessarily mean that every optical component of the fiber oscillator has a normal dispersion; rather, the effect arises at least for the sum of the optical components. Thus, while in one preferred configuration it is possible for all optical components of the fiber oscillator to have a normal dispersion, in another preferred configuration it is likewise possible for at least a first optical component of the fiber oscillator to have an anomalous dispersion, the fiber oscillator having at least one other, second optical component that has a normal dispersion that overcompensates for the anomalous dispersion of the first optical component, so that the dispersion of the fiber oscillator is normal overall.

If the wavelength of the fiber oscillator lies in the normal dispersion range, for example with the use of ytterbium or neodymium as doping element, the dispersion compensation element is provided and designed to keep the total dispersion of the fiber oscillator in the range predetermined for the fiber oscillator. If the wavelength of the fiber oscillator lies in the anomalous dispersion range, on the other hand, for example with the use of erbium, thulium or holmium as doping element, the dispersion compensation element is additionally provided and designed to bring the total dispersion into the normal range and, in so doing, into the predetermined range.

In one embodiment, the fiber oscillator comprises a plurality of dispersion compensation elements as the dispersion compensation element. What then matters, in particular, is that the overall effect of the different dispersion compensation elements in total is such that the total dispersion of the fiber oscillator lies in the predetermined range.

In one embodiment, the dispersion compensation element is arranged in the unidirectional loop.

According to one embodiment of the invention, the at least one dispersion compensation element is selected from a group consisting of a chirped fiber Bragg grating and a dispersion compensating fiber. Alternatively or additionally, the first amplifying fiber is configured to be dispersion compensating. The dispersion compensating fiber or the first amplifying fiber configured to be dispersion compensating is also referred to as a dispersion compensation fiber or dispersion-adapted fiber. Such a dispersion compensation fiber may, for example, have a fiber core that comprises rings with different refractive indices.

In one embodiment, the dispersion compensating fiber has an anomalous dispersion, in particular if for the rest the fiber oscillator has at least substantially, in particular overall—in particular with the exception of the dispersion compensating fiber-a normal dispersion that is greater than the predetermined total dispersion. In this case, the anomalous dispersion of the dispersion compensating fiber is coordinated with the normal dispersion of the other components of the fiber oscillator in such a way that the total dispersion lies in the predetermined range.

In another embodiment, the dispersion compensation element configured as a chirped fiber Bragg grating is configured as a reflector element of a reflecting arm of the unidirectional loop.

In one embodiment, the bidirectional loop has an asymmetry. In particular, according to one embodiment, the bidirectional loop is configured asymmetrically for two light pulses that travel through the bidirectional loop in opposite directions.

According to one embodiment of the invention, the bidirectional loop comprises an asymmetry element.

In one embodiment, the asymmetry element is a—in particular variably adjustable-amplifying element arranged asymmetrically in the bidirectional loop for an asymmetric amplification of the light pulses propagating in opposite directions along the bidirectional loop.

Alternatively or additionally, the asymmetry element is a—in particular variably adjustable-attenuating element arranged asymmetrically in the bidirectional loop for an asymmetric attenuation of the light pulses propagating in opposite directions along the bidirectional loop.

The asymmetry element is generally designed and/or arranged to generate a difference in the respective self-phase modulation between a light pulse propagating in a specific first direction along the bidirectional loop and a light pulse propagating in the other, second direction along the bidirectional loop.

The asymmetrically arranged amplifying element is preferably variably adjustable in respect of the gain. In particular, if the first amplifying fiber is configured as the amplifying element, a variable gain may be implemented by varying the pump power.

Alternatively or additionally, the asymmetrically arranged attenuating element is preferably variably adjustable in respect of the attenuation.

In general, a variable phase shift between the two light pulses passing in opposite directions in the bidirectional loop may be implemented by means of variable adjustment of the asymmetry element; in particular, the phase shift may be adjusted by variable driving of the asymmetry element.

In particular, according to one embodiment, the first amplifying fiber may be arranged asymmetrically in the bidirectional loop. This means in particular that the first amplifying fiber is arranged closer to the first end of the bidirectional loop than to the second end, or vice versa. Alternatively, according to another embodiment, an asymmetrically arranged attenuating element, in particular an asymmetrically arranged output coupling element, for example a tap coupler, or a filter, a polarization attenuator or the like, may be arranged in the bidirectional loop. The aforementioned embodiments may also be combined with one another.

In particular, the bidirectional loop is preferably configured as a nonlinear amplifying loop mirror (NALM). In this case, the bidirectional loop has an asymmetry so that different light pulses traveling through the bidirectional loop in different directions pass through a longer part of the bidirectional loop with a different intensity level depending on their circulation direction, since—in relation to the distance of the bidirectional loop-they are amplified and/or attenuated earlier or later. On account of the self-phase modulation in the bidirectional loop, this leads to a phase shift between two light pulses that travel oppositely to one another through the bidirectional loop, this phase shift itself in turn being intensity-dependent. The phase shift between the two light pulses in turn influences their coupling behavior at the loop coupler. In this way, light pulses are fed only above a particular intensity threshold effectively in the appropriate propagation direction via the loop coupler out of the bidirectional loop into the unidirectional loop, so that in particular the bidirectional loop configured as an NALM can fulfill the function of a saturable absorber. In particular, the NALM fiber length is adapted such that the phase difference in the NALM leads to constructive interference at the fiber output.

The loop arrangement composed of the bidirectional loop and the unidirectional loop, which are coupled to one another via the loop coupler, and therefore also the fiber oscillator overall, preferably has a so-called figure-of-eight configuration.

According to one embodiment, the unidirectional loop does not comprise any amplifying medium. In this case, the first amplifying fiber is advantageously the only amplifying medium of the fiber oscillator, in particular the only amplifying fiber. The fiber oscillator may therefore have a very simple and cost-effective structure.

According to an alternative preferred configuration, the unidirectional loop comprises an—additional-amplifying medium, in particular a second amplifying fiber, an isolator element—in a preferred configuration the isolator device of the unidirectional loop, which is provided anyway-being arranged in the propagation direction of a light pulse-preferably in the unidirectional loop-between the amplifying element and the first amplifying fiber. Additionally or alternatively, an isolator element is preferably arranged in the propagation direction of the light pulse between the first amplifying fiber and the amplifying element. With the aid of the amplifying element, losses may in particular advantageously be compensated for by amplification of light pulses in the fiber oscillator taking place not only in the first amplifying fiber but also in the additional amplifying medium. At the same time, this allows greater freedom in the selection of the gain for the first amplifying fiber and therefore freer adaptation of the phase shift between the first light pulse and the second light pulse, since a variation of the overall gain of the fiber oscillator in the event of a variation of the gain in the first amplifying fiber may correspondingly be compensated for by means of the additional amplifying medium. In particular, this configuration enables inefficient operation-explained in greater detail below—of the bidirectional loop, this operation being advantageous for the quality of the spectra of the generated seed pulses.

The isolator element may, in a preferred configuration, be configured as an isolator or as a circulator.

The second amplifying fiber is preferably doped with the same element as the first amplifying fiber.

Preferably, the bidirectional loop comprises an input coupling device, which is designed to couple pump light into the first amplifying fiber. The input coupling device arranged in the bidirectional loop may at the same time also be used to couple pump light into the additional amplifying medium, in particular into the second amplifying fiber. Furthermore, the preferably asymmetrically arranged input coupling device may be used as an asymmetry element, in particular as an asymmetrically arranged attenuating element.

Alternatively, it is preferably possible for an input coupling device, which is designed to couple pump light into the additional amplifying medium, in particular the second amplifying fiber, to be arranged in the unidirectional loop. Preferably, the input coupling device is at the same time also used to couple pump light into the first amplifying fiber.

Alternatively, it is preferably also possible for the bidirectional loop to comprise a first input coupling device for coupling pump light into the first amplifying fiber, the unidirectional loop comprising a second input coupling device, which is designed to couple pump light into the additional amplifying medium.

The input coupling device, be it the first input coupling device or the second input coupling device or a single input coupling device, is preferably configured as a wavelength division multiplexing coupler (wavelength division multiplexer—WDM).

According to one embodiment of the invention, the unidirectional loop comprises a reflecting arm, a reflector element being arranged in the reflecting arm. By means of the reflector element, according to one embodiment, additional optical functions may also be implemented, in particular the function of a bandwidth-limiting element and/or of a dispersion compensation element. The reflecting arm affords advantages with regard to the arrangement and bilateral isolation of an additional amplifying medium in the reflecting arm.

The reflecting arm preferably comprises at least one fiber or preferably consists of at least one fiber.

The reflector element is preferably arranged at a reflection end of the reflecting arm. The reflecting arm is preferably configured as a linear branch of the unidirectional loop, which is connected in light guiding fashion to a ring part of the unidirectional loop. The reflecting arm, in particular the linear branch, comprises the reflector element at the reflection end and is connected in light guiding fashion to the ring part at a terminal end situated opposite the reflection end. A light pulse traveling through the unidirectional loop travels through the reflecting arm two times, once from the terminal end to the reflection end and then back from the reflection end to the terminal end.

The reflector element is preferably configured to be partly transparent—or expressed the other way round partly reflective-so that a predetermined portion of light is coupled out from the fiber oscillator via the reflector element.

According to one embodiment of the fiber oscillator, the reflector element is configured as a wavelength fixing element, that is to say in particular as an element that is designed to establish a central wavelength for the fiber oscillator. The reflector element therefore advantageously allows unique establishment of the central wavelength with which the fiber oscillator is operated. This affords the great advantage of a high reproducibility together with increased variability in order to obtain a specific desired wavelength as the central wavelength. This may be crucial in particular in subsequent processes whose efficiency depends on the wavelength, for example in material processing processes, in an amplification chain, and/or in frequency conversion.

According to one embodiment, the reflector element is configured as a fiber Bragg grating. The fiber Bragg grating may preferably function as the dispersion compensation element, as a wavelength fixing element, and/or as a bandwidth-limiting element. In order to be able to function as the dispersion compensation element, the fiber Bragg grating is preferably configured as a chirped fiber Bragg grating. The fiber Bragg grating may also act as a wavelength fixing element or as a bandwidth-limiting element if it is configured as an unchirped fiber Bragg grating.

In one embodiment, the dispersion compensation element is formed by the reflector element, by virtue of the reflector element being configured as a chirped fiber Bragg grating.

In particular, the reflector element is the dispersion compensation element.

In one embodiment, the reflecting arm is connected in light guiding fashion via a circulator element to a ring part of the unidirectional loop. The circulator element is in this case preferably used at the same time as an isolator device of the unidirectional loop. The ring part comprises a ring branch, which is connected in light guiding fashion to the loop coupler—in particular to the third port of the 3×3 coupler—at a first ring branch end and to the reflecting arm at a second ring branch end. The ring part furthermore comprises a second ring branch, which is connected in light guiding fashion to the reflecting arm at a first ring branch end and to the loop coupler—in particular to the first port of the 3×3 coupler—at a second ring branch end. A light pulse entering via the loop coupler into the first ring branch travels through the latter to the circulator element, is coupled by the latter into the terminal end of the reflecting arm, travels through the reflecting arm to the reflector element arranged at the reflection end, is at least partially reflected there, travels along the reflecting arm back to the terminal end, is coupled there by the circulator element into the second ring branch, and travels through the latter once again to the loop coupler. The light pulse therefore respectively travels once through the first ring branch and the second ring branch, while it travels two times—in the outgoing direction and back-through the reflecting arm.

In particular, a second amplifying fiber, in particular as the additional amplifying medium already mentioned above, is arranged in the unidirectional loop, in particular in the reflecting arm. Preferably, the second amplifying fiber is arranged in the reflecting arm. This is found to be advantageous since in this way a light pulse propagating in the unidirectional loop passes through the second amplifying fiber two times, so that the light pulse is doubly amplified. Furthermore, the second amplifying fiber is advantageously separated from the first amplifying fiber by the circulator element—in particular in both directions-so that the two amplifying fibers do not disadvantageously influence one another.

The second amplifying fiber is preferably doped with the same element as the first amplifying fiber.

The fiber oscillator preferably comprises, outside the unidirectional loop, in particular outside the loop arrangement, in the propagation direction of a light pulse coupled out by the reflector element-behind the first reflector element, a coupling device for coupling pump light into the fiber oscillator, in particular into the unidirectional loop. In this way, pump light may advantageously be coupled via the reflector element into the unidirectional loop. The coupling device may, however, also be arranged inside the unidirectional loop, in particular in the reflecting arm.

In one embodiment, the fiber oscillator comprises a bandwidth-limiting element. Preferably, the bandwidth-limiting element is arranged in the unidirectional loop. By virtue of the interaction of normal dispersion and self-phase modulation, strongly chirped light pulses, which are spectrally and temporally broadened during their propagation, are generated in the fiber oscillator. The bandwidth-limiting element advantageously clips fractions on both sides of the spectrum and therefore-because of the strong chirp-shortens the light pulses not only spectrally but also temporally. In particular, in this way the boundary condition of the periodicity for a light pulse circulating in the fiber oscillator may be fulfilled.

The bandwidth-limiting element preferably has a bandwidth of from at least 4 nm to at most 100 nm, in particular to at most 30 nm, in particular from at least 5 nm to at most 20 nm.

In one embodiment, the bandwidth-limiting element is configured as a bandpass filter. This constitutes a suitable configuration of the bandwidth-limiting element.

Alternatively or additionally, provision is preferably made for the reflector element, in particular the fiber Bragg grating, to be configured as a bandwidth-limiting element. This is advantageous since there is then no need for any additional component for bandwidth limitation. In this case, the fiber Bragg grating may be configured as an unchirped fiber Bragg grating, or alternatively as a chirped fiber Bragg grating.

The fiber Bragg grating may additionally or alternatively function as the dispersion compensation element, in particular if it is configured as a chirped fiber Bragg grating.

Alternatively or additionally, a dispersion compensating fiber is preferably arranged as the dispersion compensation element in the unidirectional loop.

In one embodiment, an additional amplifying fiber is arranged in the unidirectional loop, which fiber is referred to here for linguistic differentiation as a third amplifying fiber, irrespective of whether a second amplifying fiber is additionally present. This configuration is in particular preferred in an exemplary embodiment of the fiber oscillator in which the unidirectional loop consists of a ring part, the unidirectional loop in particular not comprising a linear branch, in particular not comprising a reflecting arm. The third amplifying fiber is therefore arranged in particular in the ring part of the unidirectional loop. The third amplifying fiber can advantageously compensate for losses of the fiber oscillator and/or deliberately inefficient operation of the bidirectional loop.

According to another embodiment, however, the third amplifying fiber is provided in addition to a second amplifying fiber provided in the reflecting arm, the third amplifying fiber preferably being arranged in the ring part of the unidirectional loop in this case as well.

The third amplifying fiber is preferably doped with the same element as the first amplifying fiber—and preferably as the second amplifying fiber.

Preferably, the fiber oscillator comprises an output coupling device for output coupling of light pulses in the unidirectional loop. In this way, it is possible to couple out light pulses-whether as useful light or for checking the fiber oscillator—not only via the loop coupler, in particular the second port or the fourth or sixth port of the 3×3 coupler, but additionally or alternatively via the output coupling device. On account of the interaction of dispersion on the one hand and self-phase modulation on the other hand along the fiber oscillator, the light pulses that are coupled out have different temporal widths as a function of the position where they are coupled out. Thus, light pulses having different temporal widths may be coupled out in particular from the loop coupler, in particular from the second port of the 3×3 coupler, the fourth port of the 3×3 coupler, and via the output coupling device.

The output coupling device is preferably configured as a tap coupler.

The bandwidth-limiting element, in particular the reflector element or the bandpass filter, is preferably configured to be adjustable in respect of its bandwidth, preferably as a temperature-dependent grating, or as a grating that is sensitive to extension or compression in respect of its bandwidth.

In one embodiment, all optical components of the fiber oscillator are configured to be polarization-maintaining. This is found to be an advantageous configuration for the fiber oscillator.

In one embodiment, all optical components of the fiber oscillator are formed by fibers or consist of fibers, and in particular are fiber-based components or fiber-coupled components. In particular, the fiber oscillator preferably has no free-space components. In this case, there is no alignment outlay in connection with the fiber oscillator.

In another embodiment, however, it is also possible for the fiber oscillator to comprise at least one optical component configured as a free-space component.

The object is also achieved by providing a laser device comprising a pump light source and a fiber oscillator according to embodiments of the invention or a fiber oscillator according to one or more of the embodiments described above, wherein the pump light source and the fiber oscillator are connected to one another in light guiding fashion, so that pump light of the pump light source can be coupled into the fiber oscillator. In particular the advantages that have already been described in connection with the fiber oscillator are afforded in connection with the laser device.

According to one embodiment of the invention, the laser device comprises a control device.

The control device is preferably operatively connected to a variably drivable asymmetry element of the bidirectional loop in order to adjust the variable asymmetry element, in particular in order to adjust the nonlinear phase shift between the light pulses traveling in opposite directions through the bidirectional loop, in particular such that a difference in the B-integrals of two laser pulses traveling through the bidirectional loop in opposite directions is approximately 1 rad. Advantageously in this case—counterintuitively—the fiber oscillator, and in particular the bidirectional loop, that is to say the NALM, is deliberately operated inefficiently in order to limit the total nonlinear phase per oscillator round-trip, despite the low repetition rate. In this configuration, in particular, preferably the unidirectional loop comprises an additional amplifying medium, in particular a second and/or third amplifying fiber, whereby the inefficient operation of the NALM can advantageously be compensated for.

In particular, the control device is designed to adjust the variable asymmetry element in such a way that the difference in the B-integrals of two laser pulses traveling through the bidirectional loop in opposite directions is 1 rad.

Alternatively, the control device is designed to adjust the variable asymmetry element in such a way that the nonlinear phase shift between the light pulses traveling in opposite directions through the bidirectional loop is at most 2π/3, preferably 2π/3. Preferably, this makes it possible to cover a larger pulse duration range than-optionally only—by selecting the pump power.

In particular, the control device is preferably operatively connected to a variably drivable amplifying element in order to adjust the variably drivable amplifying element in respect of its gain.

In one embodiment, the control device is operatively connected to the pump light source and is designed to adjust a pump power of the pump light source such that a difference in the B-integrals of two laser pulses traveling through the bidirectional loop in opposite directions is approximately 1 rad.

In particular, the control device is designed to adjust the pump power of the pump light source in such a way that the difference in the B-integrals of two laser pulses traveling through the bidirectional loop in opposite directions is 1 rad.

Alternatively, the control device is designed to adjust the pump power of the pump light source in such a way that the nonlinear phase shift between the light pulses traveling in opposite directions through the bidirectional loop is at most 2π/3, preferably 2π/3.

Alternatively or additionally, the control device is preferably operatively connected to a variably drivable attenuating element in order to adjust the variably drivable attenuating element in respect of its attenuation, in particular in order to achieve one of the aforementioned effects in respect of the B-integrals or the phase shift.

Alternatively or additionally, provision is made for the control unit to be operatively connected to the bandwidth-limiting element, which is configured to be adjustable in respect of its bandwidth, in particular to the reflector element or the bandpass filter, optionally in conjunction with a further optical element, in particular a further bandwidth-limiting element, and to be designed to adjust a bandwidth of the bandwidth-limiting element, in particular to from at least 4 nm to at most 100 nm, in particular to at most 30 nm, in particular from at least 5 nm to at most 20 nm.

Preferably, in addition to the adjustable bandwidth-limiting element, the fiber oscillator also comprises a further filter element, in which case an overlap range between the bandwidth-limiting element and the filter element may be adjusted by adjusting the bandwidth of the adjustable bandwidth-limiting element. In this way, an effective bandwidth of the combination of the bandwidth-limiting element and the filter element can be adjusted very efficiently, in particular to from at least 4 nm to at most 100 nm, in particular to at most 30 nm, in particular from at least 5 nm to at most 20 nm.

The bandwidth-limiting element may in particular be thermally or mechanically adjustable, for example by heating or cooling, or by extension or compression.

An adjustable bandwidth limitation may also be achieved with a Fabry-Pérot filter, in which a distance between two surfaces responsible for the Fabry-Pérot property is varied.

The control device is preferably designed to generate a first, higher asymmetry in the bidirectional loop in a startup operating mode by driving the variably drivable asymmetry element, in order to promote rapid starting of the laser activity in the fiber oscillator, the control device being designed to drive the variably drivable asymmetry element in a continuous operating mode in order to generate a second, lower asymmetry in the bidirectional loop in order to ensure stable continuous operation of the fiber oscillator. In particular, the control device is designed to drive a variably drivable attenuating element correspondingly, in particular in order to adjust a first, higher attenuation in the startup operating mode and to adjust a second, lower attenuation in the continuous operating mode.

The object is also achieved by providing a nonlinear CPA amplification system comprising a fiber oscillator according to embodiments of the invention or a fiber oscillator of one or more of the above-described embodiments for generating seed pulses. Alternatively, the CPA amplification system comprises a laser device according to embodiments of the invention or a laser device according to one or more of the above-described embodiments for generating seed pulses. Optionally, the amplification system comprises a pulse selection apparatus for selecting or rejecting seed pulses. This apparatus may in particular be provided, although this is not necessary per se on account of the described configuration of the fiber oscillator, in particular in order to be able to additionally vary the repetition rate as required. The amplification system comprises a pulse stretcher for temporally stretching the seed pulses, an amplifier arrangement for amplifying the temporally stretched seed pulses, and a compression apparatus for temporally compressing the amplified, temporally stretched seed pulses. In particular the advantages that have already been described in connection with the fiber oscillator or the laser device are afforded in connection with the amplification system.

In the context of the present technical teaching, the fact that the amplification system is configured as a CPA amplification system means, in particular, that the amplification in the amplification system takes place according to the principle of “chirped pulse amplification” (CPA). In the context of the present technical teaching, a nonlinear CPA system is understood to mean, in particular, a CPA system which permits a specific nonlinear phase during the amplification or propagation in the fiber.

Optionally, the amplification system comprises a pulse selection apparatus for selecting or rejecting temporally stretched seed pulses, amplified, temporally stretched seed pulses, and/or compressed amplified seed pulses.

In one embodiment, the amplifier arrangement comprises at least one preamplifier and at least one main amplifier. In particular, in one embodiment, the amplifier arrangement comprises a plurality of preamplifiers and main amplifiers.

According to one embodiment of the invention, a total nonlinear phase of the amplification system is at least π rad, preferably more than π rad. This means, in particular, that the amplification system is designed in such a way that its total nonlinear phase is at least π rad, preferably more than π rad. This has the advantage that for a given stretching factor, the maximally extractable pulse energy from the amplification system can be increased. Although the compressibility of the amplified pulses is detrimentally affected by the nonlinear phase, it can be greatly influenced in particular by a suitable choice of the input spectrum. Therefore, in order to achieve the highest possible pulse energy with at the same time good compressibility of the pulses, the requirements made of the shape of the input spectra are very stringent, the fiber oscillator proposed here advantageously being suitable for satisfying these stringent requirements.

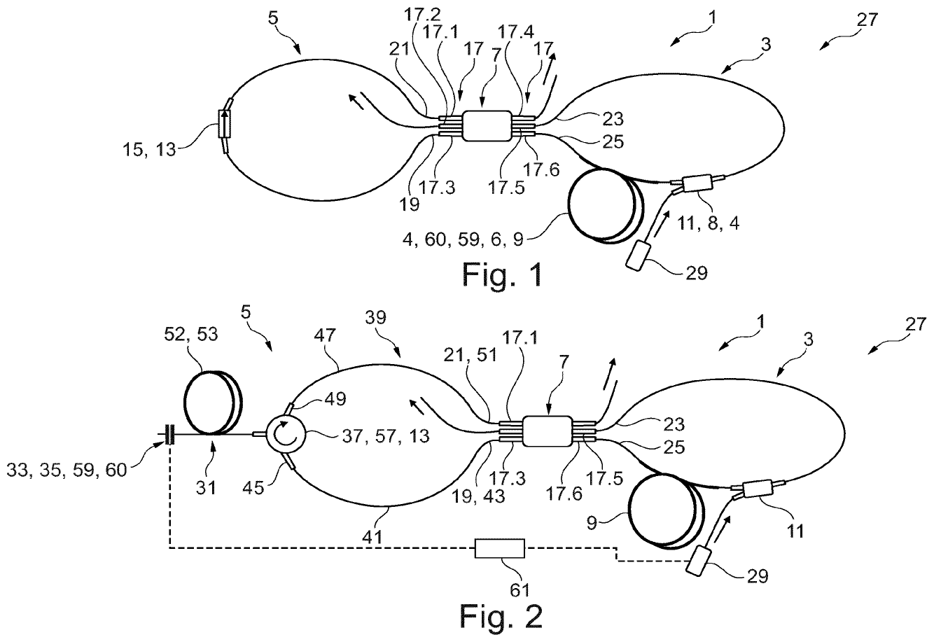

FIG. 1 shows a schematic illustration of a first exemplary embodiment of a passively mode-locked fiber oscillator 1. The fiber oscillator 1 comprises a bidirectional loop 3 and a unidirectional loop 5, the bidirectional loop 3 and the unidirectional loop 5 being coupled to one another, in particular connected to one another in light guiding fashion, by a loop coupler 7, here a 3×3 coupler. Arranged in the bidirectional loop 3, there is a first amplifying fiber 9. The fiber oscillator 1 has a total fiber length for which a repetition rate of the fiber oscillator is at most 10 MHz, and overall a normal total dispersion of 0.04 ps² to 0.1 ps². Advantageously, in this case the bidirectional loop 3 may perform the function of a saturable absorber. By way of specific tuning of the total dispersion of the fiber oscillator 1 in the predetermined range, well-defined dispersion properties are advantageously provided. In a preferred configuration, the amplifying fiber 9 is configured as a dispersion compensation element 60—and optionally additionally as a bandwidth-limiting element 59. In particular, the amplifying fiber 9 may perform the function of bandwidth limitation on the basis of its gain bandwidth.

The first amplifying fiber 9 is preferably doped with at least one element that is selected from a group consisting of: ytterbium, neodymium, erbium, holmium and thulium. The first amplifying fiber 9 may also be doped with a combination of at least two of the aforementioned elements, in particular with a combination of exactly two of these elements.

Preferably, the bidirectional loop 3 has an asymmetry for two light pulses that travel through the bidirectional loop 3 in opposite directions, in particular in the form of an asymmetry element 4. This asymmetry may, in particular, be implemented by an asymmetrically arranged amplifying element 6 and/or an asymmetrically arranged attenuating element 8 in the bidirectional loop 3. In the exemplary embodiment illustrated here, the first amplifying fiber 9 is arranged asymmetrically as an amplifying element 6 in the bidirectional loop 3. In particular, the bidirectional loop 3 is configured as a nonlinear amplifying loop mirror (NALM).

Preferably, an input coupling device 11 for coupling in pump light is arranged in the bidirectional loop 3. The input coupling device 11 is preferably configured as a wavelength division multiplexer (WDM). The input coupling device 11 may also act as an attenuating element 8 here. As an attenuating element 8, a tap coupler may for example also be arranged in the bidirectional loop 3.

An isolator device 13, in particular an isolator 15, is preferably arranged in the unidirectional loop 5.

The loop coupler 7 configured as a 3×3 coupler is preferably designed to impart a phase shift of 2π/3 to light pulses that undergo crosstalk between different direct connections of a plurality of ports 17 of the 3×3 coupler. In particular, a corresponding phase shift is then imparted to light pulses passing in opposite directions in the NALM.

Hereinafter, with reference to FIG. 1, a specific embodiment of the 3×3 coupler is described taking account of a specific possible arrangement and interconnection of the ports 17 of the 3×3 coupler. Numerous other embodiments that are equivalent, almost equivalent or at least functionally identical to the arrangement described, but at any rate fulfill the same purpose, are possible.

According to the exemplary embodiment illustrated here, the 3×3 coupler comprises in particular a first port 17.1, a second port 17.2, a third port 17.3, a fourth port 17.4, a fifth port 17.5 and a sixth port 17.6. A first end 19 of the unidirectional loop 5 is connected in light guiding fashion to the third port 17.3. A second end 21 of the unidirectional loop 5 is connected in light guiding fashion to the first port 17.1. By virtue of the configuration and arrangement of the isolator device 13, light pulses can propagate along the unidirectional loop 5 only from the third port 17.3 to the first port 17.1. A first end 23 of the bidirectional loop 3 is connected in light guiding fashion to the fifth port 17.5. A second end 25 of the bidirectional loop 3 is connected in light guiding fashion to the sixth port 17.6. The second port 17.2 and the fourth port 17.4 are preferably used to couple light pulses out of the fiber oscillator 1, whether as useful light or for monitoring.

A light pulse entering the 3×3 coupler via the first port 17.1 from the unidirectional loop 5 is split by the 3×3 coupler into three light pulses of equal pulse energy among the fourth port 17.4, the fifth port 17.5 and the sixth port 17.6. The light pulses at the fifth port 17.5 and at the sixth port 17.6 respectively experience a phase shift of 2π/3 in relation to the light pulse entering at the first port 17.1. The light pulse at the fifth port 17.5 will be referred to below as a first light pulse, and the light pulse at the sixth port 17.6 as a second light pulse. The first light pulse then travels through the bidirectional loop 3 starting from the first end 23 thereof to the second end 25 thereof, the second light pulse traveling through the bidirectional loop 3 in the opposite direction.

On account of the first amplifying fiber 9 arranged asymmetrically in the bidirectional loop 3, the first light pulse and the second light pulse then experience different phase shifts, or B-integrals, during their propagation along the bidirectional loop 3. The difference in the B-integrals, or the phase shift between the first light pulse and the second light pulse, depends in particular on the original intensity of the light pulses-before traveling through the bidirectional loop 3—and the gain in the first amplifying fiber 9, that is to say in particular on a pump level of the first amplifying fiber 9.

Having arrived at the fifth port 17.5, the second light pulse then undergoes crosstalk partially into a direct optical connection between the sixth port 17.6 and the third port 17.3, while again experiencing a phase shift of 2π/3. The first light pulse arriving at the sixth port 17.6 is forwarded directly to the third port 17.3, without experiencing a phase shift. An output pulse resulting at the third port 17.3 from superposition of the first light pulse and the second light pulse therefore depends, in particular, on the B-integrals that the light pulses experience during their propagation along the bidirectional loop 3.

Light portions that pass back into the first port 17.1 are eliminated by the isolator device 13. Only light pulses that enter the unidirectional loop 5 via the third port 17.3 are transmitted. The bidirectional loop 3 functions as a saturable absorber.

In the first exemplary embodiment of the fiber oscillator 1, the unidirectional loop 5 does not comprise any amplifying medium. In particular, here the first amplifying fiber 9 is the only amplifying medium, in particular the only amplifying fiber of the fiber oscillator 1.

FIG. 1 shows at the same time an exemplary embodiment of a laser device 27 comprising a pump light source 29 and the fiber oscillator 1, the pump light source 29 being connected in light guiding fashion to the fiber oscillator 1, in particular to the input coupling device 11, so that pump light of the pump light source 29 can be coupled into the fiber oscillator 1.

FIG. 2 shows a schematic illustration of a second exemplary embodiment of the fiber oscillator 1.

Identical and functionally identical elements are provided with the same references in all the figures, so that in this regard reference is respectively made to the preceding description.

In this exemplary embodiment, the unidirectional loop 5 comprises a reflecting arm 31, in which, in the second exemplary embodiment illustrated here, a reflector element 35 configured as a fiber Bragg grating 33 is arranged. The reflecting arm 31 is connected in light guiding fashion via a circulator element 37 to a ring part 39 of the unidirectional loop 5. In particular, the ring part 39 comprises a first ring branch 41, which is connected by a first ring branch end 43 to the third port 17.3 of the 3×3 coupler, and which is connected by a second ring branch end 45 to the circulator element 37. The ring part 39 furthermore comprises a second ring branch 47, which is connected by a first ring branch end 49 to the circulator element 37 and by a second ring branch end 51 to the first port 17.1 of the 3×3 coupler. The circulator element 37 acts here as an isolator device 13. A light pulse traveling through the unidirectional loop 5 starting from the third port 17.3 to the first port 17.1 respectively travels through the ring branches 41, 47 once, but through the reflecting arm 31 two times, namely once to the reflector element 35 and once back from the reflector element 35.

Arranged as an additional amplifying medium 52 in the reflecting arm 31, there is a second amplifying fiber 53, which is preferably doped with the same element as that with which the first amplifying fiber 9 is also doped. The amplifying medium 52, in particular the second amplifying fiber 53, may however also be arranged elsewhere in the fiber oscillator 1.

The reflector element 35 is preferably configured to be partly transmissive or partly reflective, wherein on the one hand a predetermined portion of light is coupled out of the fiber oscillator 1 via the reflector element 35, and on the other hand pump light for the second amplifying fiber 53 is preferably coupled into the unidirectional loop 5 via the reflector element 35.

The circulator element 37 acts, in particular, as an isolator element 57 in the unidirectional loop 5.

The reflector element 35 is preferably configured as a bandwidth-limiting element 59; in particular, the fiber Bragg grating 33—unchirped according to one configuration—is preferably configured as a bandwidth-limiting element 59. In a preferred configuration, it is possible for the bandwidth-limiting element 59 to be configured to be adjustable—in particular thermally or mechanically—in respect of its bandwidth.

The bandwidth-limiting element 59 preferably has a bandwidth of from at least 4 nm to at most 100 nm, in particular to at most 30 nm, in particular from at least 5 nm to at most 20 nm.

In particular, if the fiber Bragg grating 33 is configured as a chirped fiber Bragg grating 33, additionally or alternatively, it can function as the dispersion compensation element 60.

FIG. 2 furthermore shows a second exemplary embodiment of the laser device 27, which in a preferred configuration comprises a control device 61, the control device 61 being operatively connected to the pump light source 29 and preferably being designed to adjust a pulse duration of the fiber oscillator 1 by selecting the pump power of the pump light source 29.

The control device 61 is alternatively or additionally designed, by way of suitable driving of the pump light source 29, to adjust the nonlinear phase shift between the light pulses traveling in opposite directions through the bidirectional loop, in particular such that a difference in the B-integrals of two laser pulses traveling through the bidirectional loop in opposite directions is approximately 1 rad. Advantageously, in this case—counterintuitively—the fiber oscillator 1, and in particular the NALM, is deliberately operated inefficiently in order to obtain smooth spectra at a low repetition rate. This inefficient operation is advantageously compensated for here by the additional amplifying medium 52, in particular the second amplifying fiber 53.

The control device 61 is alternatively or additionally operatively connected to the bandwidth-limiting element 59, which is preferably configured to be adjustable—in particular thermally or mechanically—in respect of its bandwidth, and is designed to adjust a bandwidth of the bandwidth-limiting element 59, in particular in order preferably to be able to cover a larger pulse duration range than-optionally only—by selecting the pump power.

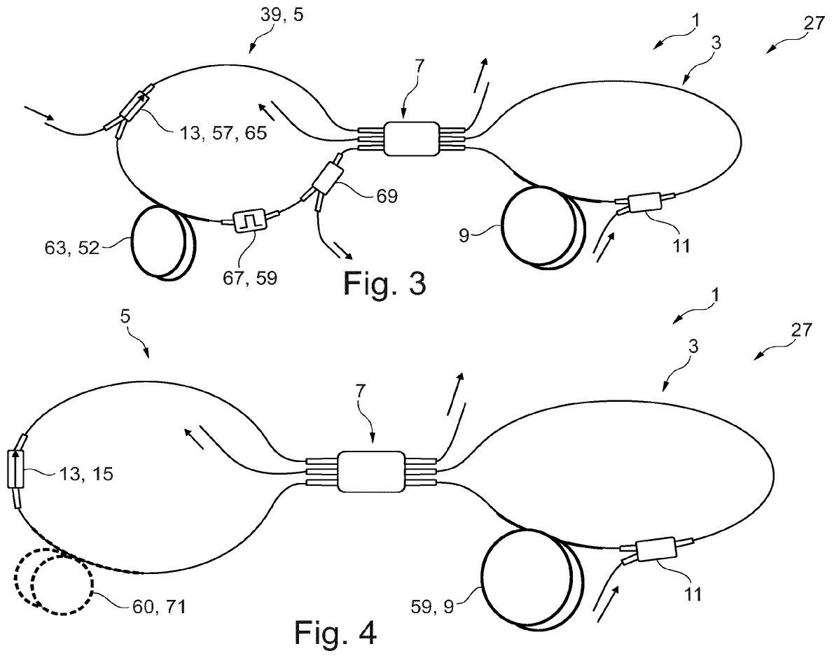

FIG. 3 shows a schematic illustration of a third exemplary embodiment of the fiber oscillator 1.

In this third exemplary embodiment, the unidirectional loop 5 consists of the ring part 39—it accordingly does not comprise a reflecting arm 31—and comprises the additional amplifying medium 52, here a third amplifying fiber 63, in the ring part 39, the third amplifying fiber 63 preferably being doped with the same element as the first amplifying fiber 9. The isolator device 13 is arranged as the isolator element 57 in the propagation direction behind the third amplifying fiber 63.

The isolator device 13 is here configured at the same time as a second input coupling device 65—in addition to the input coupling device 11, which to this extent is a first input coupling device—for input coupling of pump light for the third amplifying fiber 63, in particular as a wavelength division multiplexer.

Moreover, a-preferably adjustable-bandpass filter 67 is optionally arranged as the bandwidth-limiting element 59 in the unidirectional loop 5 in the propagation direction before the third amplifying fiber 63.

Furthermore, an output coupling device 69, which is preferably configured as a tap coupler, is optionally arranged in the unidirectional loop 5. Via the output coupling device 69, in particular, useful light or light for monitoring the fiber oscillator 1 may optionally be coupled out. In this third exemplary embodiment, too, in particular the first amplifying fiber 9 may function as the dispersion compensation element 60.

FIG. 4 shows a schematic illustration of a fourth exemplary embodiment of the fiber oscillator 1. In this fourth exemplary embodiment, a dispersion compensating fiber 71 is arranged as a dispersion compensation element 60 in the unidirectional loop 5.

With the aid of the dispersion compensation element 60 irrespective of its configuration—in particular according to FIG. 2 or FIG. 4—it is possible to adjust the—normal-total dispersion of the fiber oscillator 1 to the predetermined range.

Preferably, a bandwidth-limiting element 59 is provided in this exemplary embodiment, too. In particular, the first amplifying fiber 9 may be configured as a bandwidth-limiting element 59. Alternatively or additionally, for example, a bandpass filter may also be provided as bandwidth-limiting element 59.

Irrespective of the specific configuration of the fiber oscillator 1—in particular according to one of the exemplary embodiments described above-preferably all optical components of the fiber oscillator 1 are configured to be polarization-maintaining.

Preferably, all optical components of the fiber oscillator 1 are fiber components or fiber-based components, or fiber-coupled components. In particular, the fiber oscillator 1 preferably has no free-space component.

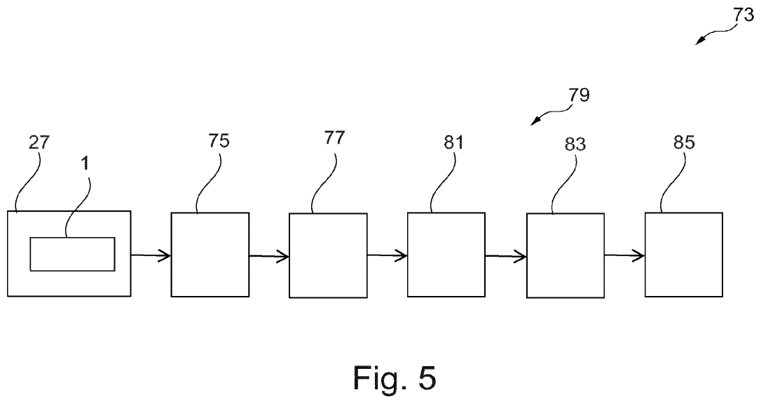

FIG. 5 shows a schematic illustration of one exemplary embodiment of a nonlinear CPA amplification system 73 comprising a passively mode-locked fiber oscillator 1.

The nonlinear CPA amplification system 73 comprises the fiber oscillator 1, in particular the laser device 27, for generating seed pulses. Optionally, the CPA amplification system 73 comprises a pulse stretcher 75 for selecting or rejecting seed pulses, furthermore a pulse selection apparatus 77 for temporally stretching the seed pulses, an amplifier arrangement 79 for amplifying the temporally stretched seed pulses, in particular comprising at least one preamplifier 81 and at least one main amplifier 83, and a compression apparatus 85 for temporally compressing the amplified, temporally stretched seed pulses. A total nonlinear phase of the CPA application system 73 is preferably at least π rad.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A passively mode-locked fiber oscillator for generating seed pulses for nonlinear chirped pulse amplification (CPA) systems, the fiber oscillator comprising:
a bidirectional loop and a unidirectional loop coupled to one another by a loop coupler, wherein
the bidirectional loop comprises a first amplifying fiber, and
the fiber oscillator has a total fiber length configured such that a repetition rate of the fiber oscillator is at most 10 MHz,
the fiber oscillator further comprising at least one dispersion compensation element configured such that the fiber oscillator has a total dispersion of 0.04 ps² to 0.1 ps².

2. The fiber oscillator as claimed in claim 1, wherein the total fiber length is configured such that the repetition rate of the fiber oscillator is at most 5 MHz.

3. The fiber oscillator as claimed in claim 1, wherein the total fiber length is at least 20 m.

4. The fiber oscillator as claimed in claim 1, wherein the loop coupler is configured as a 3×3 coupler.

5. The fiber oscillator as claimed in claim 1, wherein the first amplifying fiber is doped with ytterbium.

6. The fiber oscillator as claimed in claim 1, wherein the at least one dispersion compensation element comprises a chirped fiber Bragg grating or a dispersion compensating fiber.

7. The fiber oscillator as claimed in claim 1, wherein the bidirectional loop comprises an asymmetry element.

8. The fiber oscillator as claimed in claim 1, wherein the bidirectional loop comprises an asymmetrically arranged attenuating element.

9. The fiber oscillator as claimed in claim 1, wherein the bidirectional loop comprises an asymmetrically arranged amplifying element.

10. The fiber oscillator as claimed in claim 1, wherein the unidirectional loop comprises a reflecting arm, wherein a reflector element is arranged in the reflecting arm, and wherein the reflecting arm is connected in a light guiding fashion via a circulator element to a ring part of the unidirectional loop.

11. The fiber oscillator as claimed in claim 10, wherein the unidirectional loop comprises a second amplifying fiber arranged in the reflecting arm.

12. A laser device, comprising a pump light source and a fiber oscillator as claimed in claim 1, wherein the pump light source and the fiber oscillator are connected to one another in a light guiding fashion, so that pump light of the pump light source is coupled into the fiber oscillator.

13. The laser device as claimed in claim 12, further comprising a control device, wherein the control device is operatively connected to the pump light source and is configured to adjust a pump power of the pump light source such that a difference in B-integrals of two laser pulses traveling through the bidirectional loop in opposite directions is approximately 1 rad.

14. A nonlinear chirped pulse amplification (CPA) system, comprising:
a laser device as claimed in claim 12 for generating seed pulses,
a pulse selection apparatus for selecting or rejecting the seed pulses,
a pulse stretcher for temporally stretching the seed pulses to obtain temporally stretched seed pulses,
an amplifier arrangement for amplifying the temporally stretched seed pulses to obtain amplified and temporally stretched seed pulses, and
a compression apparatus for temporally compressing the amplified and temporally stretched seed pulses.

15. The nonlinear CPA system as claimed in claim 14, wherein a total nonlinear phase of the nonlinear CPA system is at least π rad.
